(19) United States
(12) Patent Application Publication
(10) Pub. No.: US 2026/0208103 A1
(43) Pub. Date: Jul. 23, 2026

(54) DIRECT AIR CAPTURE OF CARBON DIOXIDE WITH MOLECULAR POLYAMINES

(71) Applicant: THE REGENTS OF THE UNIVERSITY OF CALIFORNIA, Oakland, CA (US)

(72) Inventors: Adrian Huang, Berkeley, CA (US); Jeffrey R. Long, Oakland, CA (US)

(73) Assignee: THE REGENTS OF THE UNIVERSITY OF CALIFORNIA, Oakland, CA (US)

(21) Appl. No.: 19/556,256

(22) Filed: Mar. 4, 2026

Related U.S. Application Data
(63) Continuation of application No. PCT/US2024/049673, filed on Oct. 2, 2024.
(60) Provisional application No. 63/587,467, filed on Oct. 3, 2023.

(51) Int. Cl. B01D 53/82; B01D 53/62; B01J 20/26; B01J 20/28; B01J 20/32

(52) U.S. Cl. CPC B01D 53/82; B01D 53/62; B01J 20/26; B01J 20/28033; B01J 20/3206; B01J 20/3219; B01J 20/3268; B01D 2253/202; B01D 2257/504; B01D 2258/06

(57) ABSTRACT

When exposed to air at ambient conditions, solid-state molecular polyamine 1,3,5-tris(aminomethyl)benzene C₆H₃(CH₂NH₂)₃ (hereafter TriH) readily captures CO₂ via a cooperative phase transition. Importantly, this material stands in a class of its own with respect to direct air capture materials as the mechanism of CO₂ capture, a rapid phase transition upon capture to yield a crystalline, porous ammonium carbamate network, is unprecedented. Additionally, the use of molecular sorbents enables a high density of amine sites, resulting in unprecedented CO₂ sorption capacities. TriH has demonstrated exceptional kinetics and sorption capacities under simulated air between 20% and 80% relative humidity as well as 10° C. to 40° C., which are conditions encompassing a majority of naturally occurring climates.

### CROSS-REFERENCE TO RELATED APPLICATIONS

This application claims priority to, and is a 35 U.S.C. § 111(a) continuation of, PCT international application number PCT/US2024/049673 filed on Oct. 2, 2024, incorporated herein by reference in its entirety, which claims priority to, and the benefit of, U.S. provisional patent application Ser. No. 63/587,467 filed on Oct. 3, 2023, incorporated herein by reference in its entirety. Priority is claimed to each of the foregoing applications.

The above-referenced PCT international application was published as PCT International Publication No. WO 2025/076148 A1 on Apr. 10, 2025, which publication is incorporated herein by reference in its entirety.

### STATEMENT REGARDING FEDERALLY SPONSORED RESEARCH OR DEVELOPMENT

This invention was made with Government support under grant numbers DE-SC0019992 and DE-AC02-05CH11231, awarded by the United States Department of Energy. The Government has certain rights in the invention.

### NOTICE OF MATERIAL SUBJECT TO COPYRIGHT PROTECTION

A portion of the material in this patent document may be subject to copyright protection under the copyright laws of the United States and of other countries. The owner of the copyright rights has no objection to the facsimile reproduction by anyone of the patent document or the patent disclosure, as it appears in the United States Patent and Trademark Office publicly available file or records, but otherwise reserves all copyright rights whatsoever. The copyright owner does not hereby waive any of its rights to have this patent document maintained in secrecy, including without limitation its rights pursuant to 37 C.F.R. § 1.14.

### BACKGROUND

### 1. Technical Field

This technology pertains generally to methods and compositions for gas separations and capture and more particularly to a class of CO₂-selective molecular polyamines that can absorb CO₂ from air or composite gas streams. The molecular polyamines compositions can reversibly recover CO₂ from ambient air or composite gas streams with the air-Induced assembly of ammonium carbamate network solids.

### 2. Background

Among the most challenging CO₂ separations is the removal of CO₂ directly from air. For example, it is necessary to remove CO₂ the air to minimize solid CO₂ formation on the heat exchangers prior to the cryogenic distillation of air for N₂, O₂, and Ar production.

Direct air capture (DAC) refers to the removal of carbon dioxide (CO₂) from air that is recognized as a promising negative emissions technology that may mitigate the negative effects of anthropogenic climate change and may help achieve carbon negative emission benchmarks set forth by international treaties.

DAC is projected to play a particularly important role in offsetting CO₂ emissions from industries that are difficult to decarbonize as well as addressing legacy emissions. The ultra-dilute concentration of CO₂ in air (~420 ppm) poses a challenge towards the discovery of effective DAC materials. In order to have such an impact, DAC must ultimately be deployed on a gigaton scale, which will require capture media that, at a minimum, are highly selective for CO₂ at the ultra-dilute concentrations that are found in ambient air.

In addition, effective DAC materials will need to exhibit rapid sorption kinetics, high CO₂ capture capacities, and stability within water vapor and oxygen-rich streams. DAC technologies being commercially explored include aqueous basic solutions and mesoporous amine-functionalized substrates, yet the former case requires extremely high operation temperatures (>800° C.) for sorbent regeneration while the latter case struggles with sluggish CO₂ sorption kinetics. The shortcomings of these technologies highlight the need for accelerated development of new, high-performance DAC materials.

Porous amine-appended adsorbents, such as polyamine-functionalized metal-organic frameworks (MOFs), are attractive materials for DAC due to their crystallinity, high internal surface areas, and chemical tunability. A number of amine-appended MOFs have been found to exhibit moderately high CO₂ capacities at concentrations near 420 ppm CO₂ with mild regeneration temperatures. Yet, the sorption capacities of such hybrid inorganic-organic systems are inherently limited by the weight of the framework, which is necessary only to imbue polyamines with sufficient porosity for facile air diffusion kinetics.

Similarly, light-weight iminoguanidines have been able to achieve higher gravimetric CO₂ capacities by reacting with low concentrations of CO₂ in aqueous media. The capture of CO₂ results in the formation of iminoguanidinium carbonate hydrogen-bonded organic frameworks which can desorb CO₂ at relatively low temperatures (e.g., 120-150° C.). Yet, operation in aqueous media is undesirable as a result of the additional thermal energy required to volatilize co-absorbed water. Additionally, for both material classes, the multistep processes involved in CO₂ capture and absorbent regeneration result in systematic inefficiencies that limit high-throughput of DAC.

Accordingly, there is a need for improved processes and methods for forming materials that will address these challenges.

### BRIEF SUMMARY

Compositions and methods are provided that permit direct air capture of CO₂ using molecular polyamines that can absorb CO₂ from air and assemble a porous network solid. More generally, these absorbents can capture CO₂ from many CO₂ enriched streams (coal emissions for example), not just air and may include organic polyamines capable of forming ammonium carbamate solids. Taking inspiration from amine-based adsorbents and iminoguanidines, a class of solid-state molecular polyamines is provided that are capable of chemisorbing CO₂ through a phase change mechanism while demonstrating high gravimetric CO₂ capacities and rapid sorption kinetics.

The preferred compositions for carbon dioxide gas separations are a plurality of molecular polyamines that are capable of a phase transition upon CO₂ capture are coupled to a substrate. In one embodiment, the substrate is a porous membrane or thin film that is configured to improve thermal stability and cycling capacity of the materials. In another embodiment, the substrate is a column coated with a thin film or polymer powder configured to minimize energy costs for thermal regeneration.

The preferred molecular polyamines have a rigid core with organic linkers of one, two or three carbons and each linker is bonded to at least one amine and to the rigid core. Preferred cores include benzene, naphthalene, anthracene and pyrene. Amine density can be controlled with the number of linkers and core structures that are selected. The CO₂ separation characteristics of the molecular polyamines may also be tuned with rigid core substituents that are configured to increase hydrophilicity and saturation kinetics for CO₂ such as F, CH₃ and OH. The selection of rigid core, substituents, linkers and amine density allow the separation materials and conditions to be optimized.

The molecular polyamine triamine 1,3,5-tris(aminomethyl)benzene C₆H₃(CH₂NH₂)₃ (TriH) is used to illustrate the class.

For carbon dioxide gas separations, one preferred embodiment of the methods have the steps of (a) selecting and providing a bed of solid-state molecular polyamines capable of a phase transition upon CO₂ capture; (b) exposing the bed of solid-state molecular polyamines to a flow of gases containing CO₂ to be captured; (c) adsorbing CO₂ with the solid-state molecular polyamines producing an ammonium carbamate species that engage in intermolecular hydrogen bonding interactions to form a crystalline network solid; and (d) isolating the crystalline material after a period of time and desorbing CO₂ with heating and a vacuum swing.

In one embodiment, the reactor gas flow temperature is controlled to reduce potential volatilization of the bed or column during adsorption. In another embodiment, the relative humidity of the gas flow through the reactor is controlled to optimize CO₂ sorption capacity.

Further aspects of the technology described herein will be brought out in the following portions of the specification, wherein the detailed description is for the purpose of fully disclosing preferred embodiments of the technology without placing limitations thereon.

### BRIEF DESCRIPTION OF THE DRAWINGS

The technology described herein will be more fully understood by reference to the following drawings which are for illustrative purposes only:

FIG. 1 is a schematic depiction of molecular polyamines absorbing CO₂ to form porous ammonium carbamate networks according to one embodiment of the technology.

FIG. 2 is a schematic illustration of the solid-state structure of TriH and TriHCO₂ and the reactivity that occurs upon air exposure to produce air induced assembly of ammonium carbamate networks.

FIG. 3 is parallel-sheet perspective of the extended network structure of TriHCO₂. Dashed lines illustrate a porous honeycomb unit.

FIG. 4 is a schematic illustration with a through-sheet perspective of TriHCO₂ network of FIG. 3. Dashed black lines illustrate hydrogen bonding interactions. Carbon-hydrogen protons are omitted.

FIG. 5 depicts a reaction scheme for the synthesis of TriH according to one embodiment of the technology.

FIG. 6 is a plot of in-situ PXRD of TriH in air at 298 K results according to the technology.

FIG. 7 is a plot of in situ DRIFTS data obtained at 298 K upon air exposure.

FIG. 8 is a plot of a ¹H→¹³C HETCOR (contact time=100 μs) spectrum of TriHCO₂ with correlation assignments.

FIG. 9 is a plot of ¹H→¹⁵N HETCOR (contact time=100 μs) spectrum of TriHCO₂ with correlation assignments.

FIG. 10 is a plot of ) CO₂ absorption isobars for TriH at various partial pressures of CO₂ and N₂.

FIG. 11 is a plot of absorption isotherms for TriH at 30, 40, 50, and 60° C.

FIG. 12 is a plot showing kinetic traces of absorption isotherms for TriH under 400 ppm CO₂ at 30, 40, 50, and 60° C.

FIG. 13 is a plot of kinetic traces of absorption isotherms for TriH under at 60° C. under various sub-ambient pressures of CO₂.

FIG. 14 is a plot of a CO₂ breakthrough profile for TriH under 400 ppm CO₂ at 20° C. and 0, 20, 40, 60, and 80% relative humidity (RH).

FIG. 15 is a plot of a CO₂ breakthrough profile for TriH under 400 ppm CO₂ and 80% RH at 10, 20, 30, and 40° C.

FIG. 16 is a plot showing CO₂ breakthrough cycles for TriH under 420 ppm CO₂ balanced with simulated air at 20° C.

FIG. 17 illustrates examples of molecular polyamine variations of the rigid aryl core of TriH showing increasing size of the core expected to produce increased thermal stability and additional porous phases.

FIG. 18 is a schematic illustration of methylamine density variants of TriH showing increasing amine density for CO₂ sorption and higher sorption capacity and new porous phases.

FIG. 19 is a schematic illustration of aryl functionalization variants of TriH showing increasing hydrophilicity and affinity for water co-adsorption with anticipated faster saturation kinetics for CO₂ sorption.

FIG. 20 is a schematic illustration of three-dimensional rigid core variants of TriH according to the technology.

### DETAILED DESCRIPTION

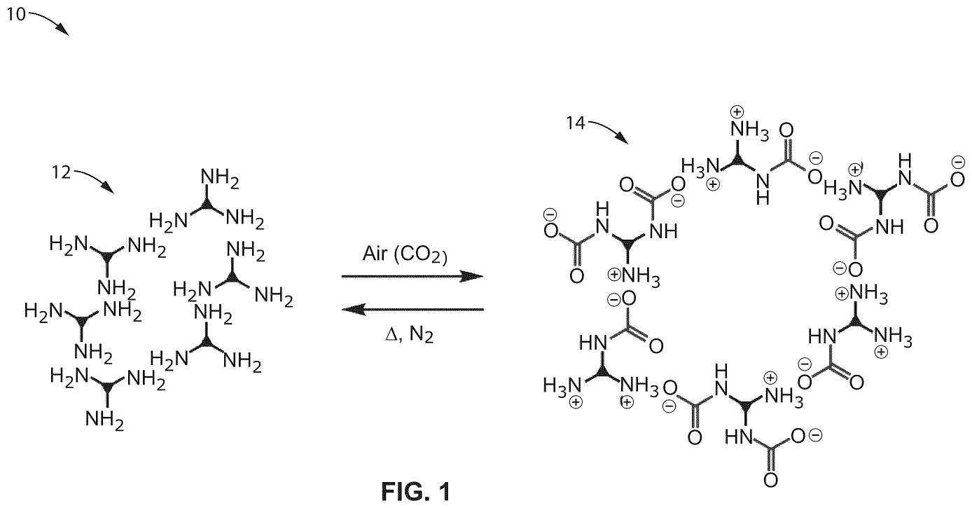

Referring more specifically to the drawings, for illustrative purposes, compositions, materials and methods for the capture of CO₂ and other organic polyamines capable of forming ammonium carbamate solids from air or composite gas streams are generally shown. Several embodiments of the technology are described generally in FIG. 1 to FIG. 20 to illustrate the characteristics and functionality of the family of molecular polyamine absorbent compositions and methods. It will be appreciated that the methods may vary as to the specific steps and sequence and the systems and apparatus may vary as to structural details without departing from the basic concepts as disclosed herein. The method steps are merely exemplary of the order that these steps may occur. The steps may occur in any order that is desired, such that it still performs the goals of the claimed technology.

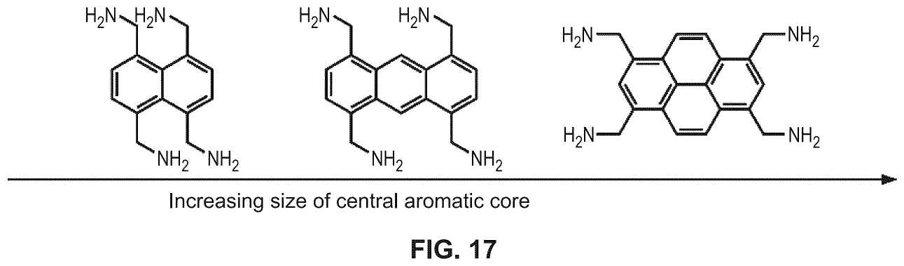

A new class of solid-state molecular polyamines that are capable of chemisorbing CO₂ through a phase change mechanism while demonstrating high gravimetric CO₂ capacities and rapid sorption kinetics is provided. The class is illustrated with molecular triamine 1,3,5-tris(aminomethyl)benzene C₆H₃(CH₂NH₂)₃ (abbreviated TriH) that, when exposed to air at 20° C., readily captures CO₂ via a cooperative phase transition to yield a crystalline ammonium carbamate network as shown in FIG. 1 through FIG. 3. Other members of the class with different aromatic cores and substituents are illustrated schematically in FIG. 17 through FIG. 20.

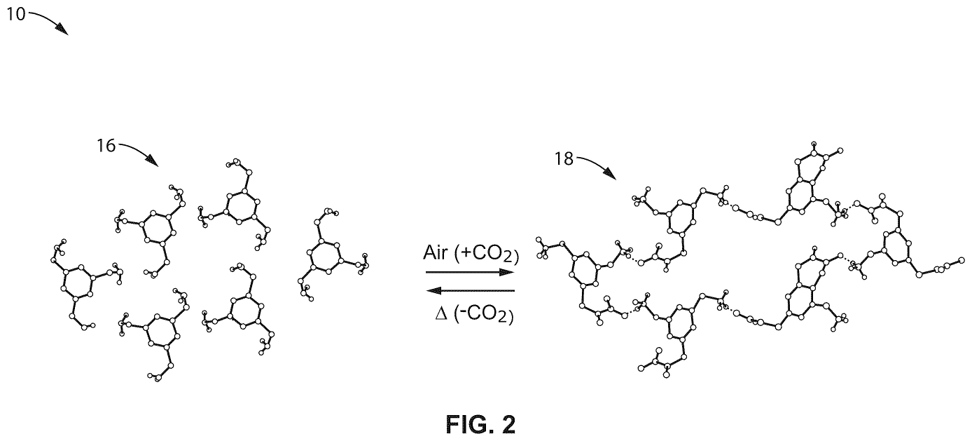

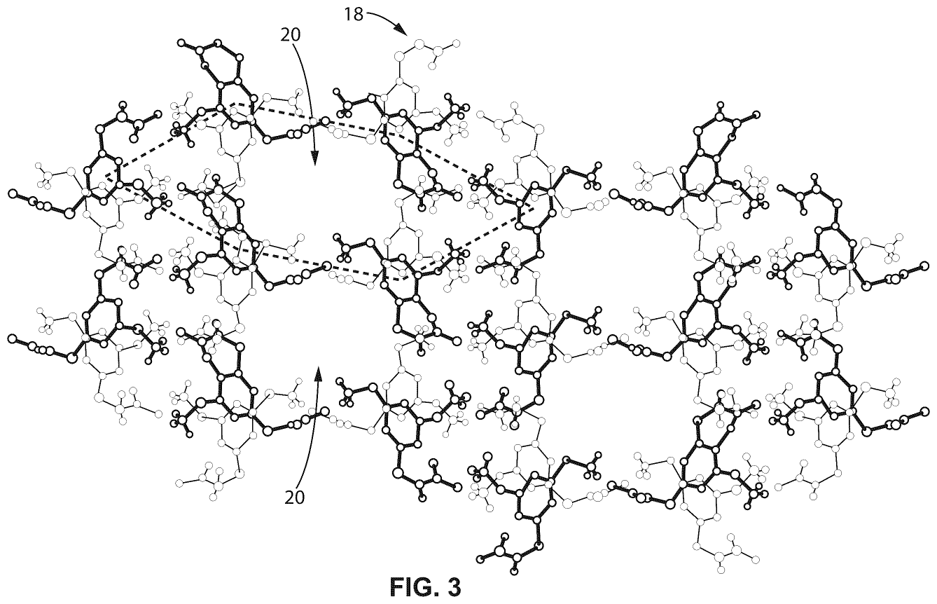

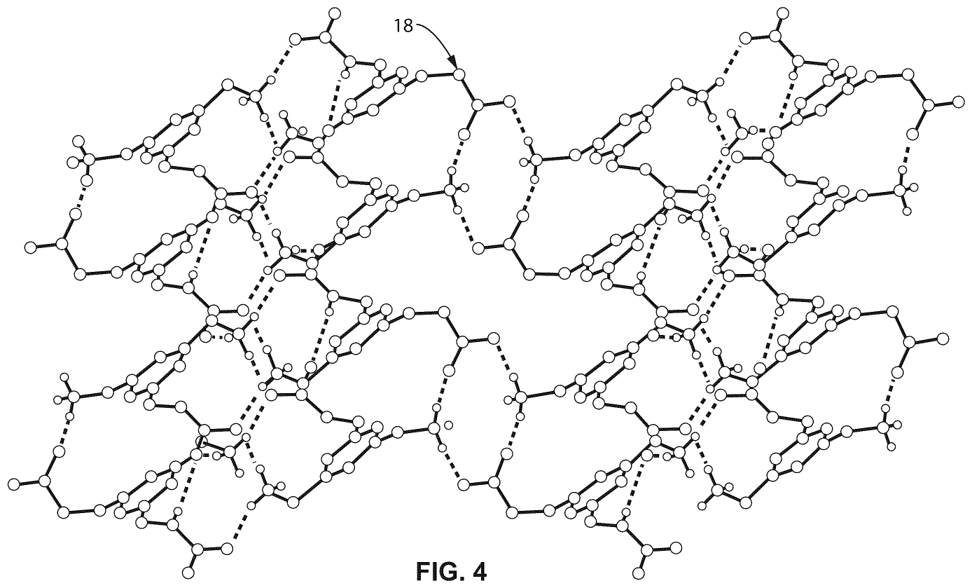

Turning now to FIG. 1, a conceptual scheme 10 of molecular polyamines 12 absorbing CO₂ and the air-induced assembly of ammonium carbamate network solids 14 from TriH is shown schematically. FIG. 2 is an illustration of the solid-state structure of TriH 16 and TriHCO₂ 18 and the reactivity that occurs upon air exposure or effluent exposure. FIG. 3 depicts a parallel-sheet perspective of the extended network structure of TriHCO₂ and FIG. 4 is a through sheet perspective of TriHCO₂. These absorbents may find possible uses in capturing CO₂ not only from air but also from point source emissions with higher concentrations of CO₂.

As illustrated in FIG. 1 to FIG. 4, the molecular polyamines absorb CO₂ to form porous ammonium carbamate networks under comparatively mild conditions. Absorbent regeneration can be facilitated by a temperature or pressure swing, enabling a simple process for absorbent regeneration.

High symmetry molecular polyamines featuring a central rigid core and pendant amine moieties are presented. Upon CO₂ sorption, the resulting ammonium carbamate species engage in intermolecular hydrogen bonding interactions to form a crystalline network solid. The resulting ammonium carbamate species tether rigid molecular cores together via hydrogen bonding interactions. Such materials would demonstrate rapid sorption kinetics due to pore assembly and high CO₂ capacities due to the high concentration of amine groups.

Single-crystal X-ray diffraction (SCXRD) quality crystals of the ammonium carbamate product (hereafter TriHCO₂) were prepared by dissolving roughly 25 mg of TriHCO₂ in water (1 mL) and layering methanol (3 mL) above the solution. Over the course of two days, hexagonal single crystals of TriHCO₂ began to grow. The structure reveals that CO₂ has been inserted into one or two of the amine groups of each molecule, while the remaining one or two amine groups have accepted a proton to form charge balancing ammonium ions. These molecular ions feature one or two carbamates and two or one ammonium ions, respectively, that are connected via an extensive three-dimensional hydrogen bonding network. These pairs orient within the crystalline lattice to form stacked layers of honeycomb sheets featuring one-dimensional channels 20 as shown in FIG. 3. The long-range order of the stacked honeycomb sheets is governed by intermolecular interactions to construct a three-dimensional ammonium carbamate network as illustrated in FIG. 4.

The class of molecular polyamines are capable of directly capturing CO₂ from air in a wide range of climates. The CO₂ absorption mechanism of TriH results in a crystallographic phase transition to form a porous ammonium carbamate network solid. While the utility of TriH for direct air capture (DAC) has been demonstrated, CO₂ capture would also be possible from other sources beyond just air as long as CO₂ concentrations exceed about 400 ppm.

It will be appreciated that the TriH material is particularly preferred within the class of solid-state molecular polyamines capable of a phase transition upon CO₂ capture to afford a porous network solid. The fundamental idea of using solid-state molecular species hinging on rotationally free amine moieties around a central rigid core is an important feature of the material. In contrast to common porous materials such as zeolites and MOFs, it is anticipated that the simplicity of the molecular structure of TriH will enable the ease of large-scale synthesis. In addition, current DAC materials struggle with at least one of the following: cycling capacity, sorption kinetics, regeneration conditions, or tolerance to humidity/oxygen. The TriH material demonstrates remarkably high gravimetric CO₂ sorption capacities that outperform commercially mature DAC technologies. Furthermore, as TriH exhibits rapid CO₂ capture from air at a variety of relative humidities and temperatures, it is possible to deploy TriH for DAC across many capture climates.

In addition, due to its low molecular weight, the TriH material is susceptible to volatilization at elevated temperatures, potentially hindering sorbent stability. Various substrates and engineering solutions could be examined to minimize or eliminate volatilization altogether. For example, confining TriH in a permeable matrix, such as a porous membrane or thin film, may improve its thermal stability and therefore its practical cycling capacity. Alternative solutions also include downstream recovery of the volatilized amine, which could further reduce sorbent material cost.

In effort to maximize the quantity of CO₂ that is effectively removed from the atmosphere, it is believed that the TriH compositions will perform the most effectively in a batch process. Large-scale deployment of TriH in warm and humid climates will lead to optimal performance in regards to rapid sorption kinetics and high gravimetric CO₂ capacity. To maximize the rate of CO₂ sorption, TriH has been prepared as a loose powder or thin film to coat a column to minimize energy costs for thermal regeneration. Also, initial filtration of small particulates may improve the long-term stability of TriH. It is expected that a breakthrough process through the substrate will be the best process in which TriH captures CO₂.

The technology described herein may be better understood with reference to the accompanying examples, which are intended for purposes of illustration only and should not be construed as in any sense limiting the scope of the technology described herein as defined in the claims appended hereto.

### Example 1

To demonstrate the breadth and functionality of the compositions and methods for carbon dioxide separations, the molecular triamine 1,3,5-tris(aminomethyl)benzene C₆H₃(CH₂NH₂)₃ (TriH) and variants were synthesized.

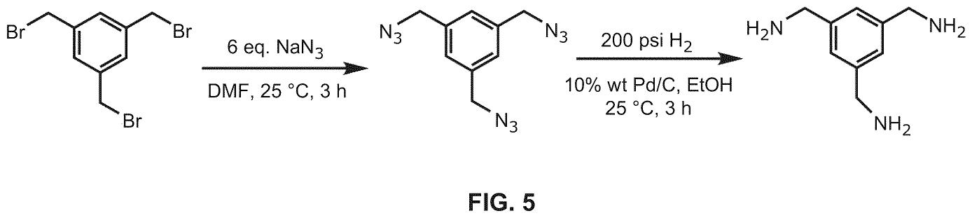

TriH can be readily synthesized on a gram scale as shown schematically in FIG. 5. In this embodiment, 2.5 g (7.0 mmol) of 1,3,5-Tris(bromomethyl)benzene was dissolved in 40 mL of DMF. Then 2.73 g (42.0 mmol) of sodium azide was mixed and allowed to stir at room temperature for at least three hours. Next, 40 mL of ethyl acetate was added, and the solution was washed with distilled water (3×35 mL) and a saturated NaCl brine solution (35 mL). The organic fractions were dried over Na₂SO_{4,} and the ethyl acetate was then removed in vacuo to give 1,3,5-Tris(azidomethyl)benzene (1.55 g, 6.37 mmol, 91%).

Thereafter, 1.45 g (6.0 mmol) of 1,3,5-Tris(azidomethyl)benzene was dissolved in 40 mL of EtOH, and 140 mg of Pd/C was added and the reaction flask that was placed inside of a pressure reactor. The reactor was pressurized to 200 psi and stirred for at least 3 hours at room temperature. The solution was filtered over Celite and washed with 50 mL EtOH. The solvent was removed in vacuo to yield a clear oil which was purified via sublimation to afford TriH (680 mg, 4.12 mmol, 69%) as a white powder.

### Example 2

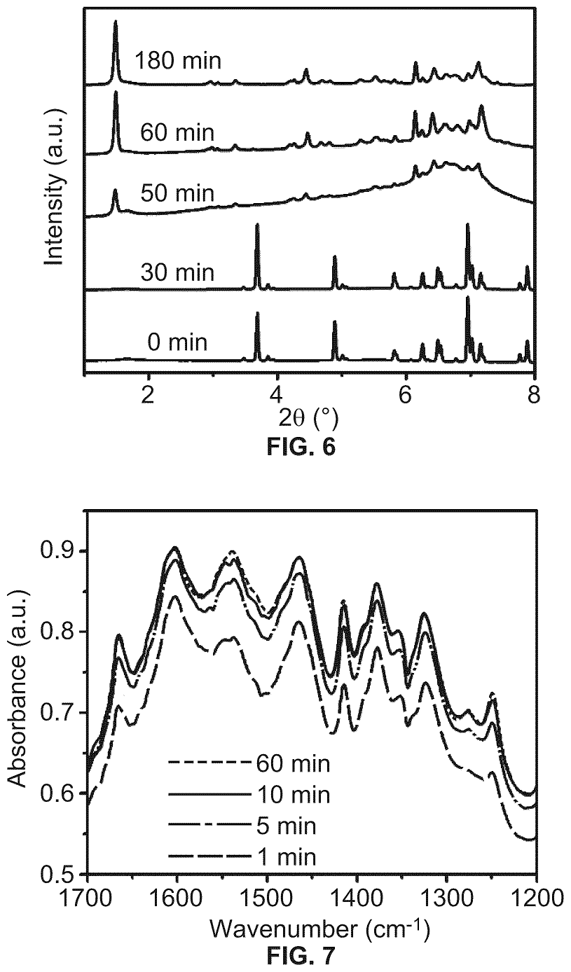

The full structural and spectroscopic characterization of the TriH material was performed. In-situ powder X-ray diffraction (PXRD) experiments were conducted by exposing TriH to air (420 ppm CO₂, 21% O₂, 79% N₂, 35% relative humidity) at 20° C. and periodically packing the sample powder into 1.1 mm OD Kapton capillaries for PXRD measurements at five-minute intervals. Transformation from the crystalline phase of TriH to TriHCO₂ agrees with the PXRD patterns predicted by SCXRD and completes within an hour of air exposure as shown in the plots of FIG. 6.

Additionally, in-situ diffuse reflectance infrared Fourier spectroscopy (DRIFTS) was performed with a sample of TriH (1 mg) homogeneously dispersed in 30 μm 10 Carat diamond powder (100 mg). Upon air exposure, ammonium carbamate formation is evident within one minute based on characteristic carbamate resonances at 1663, 1415, and 1324 cm⁻¹ as shown in the results of FIG. 7.

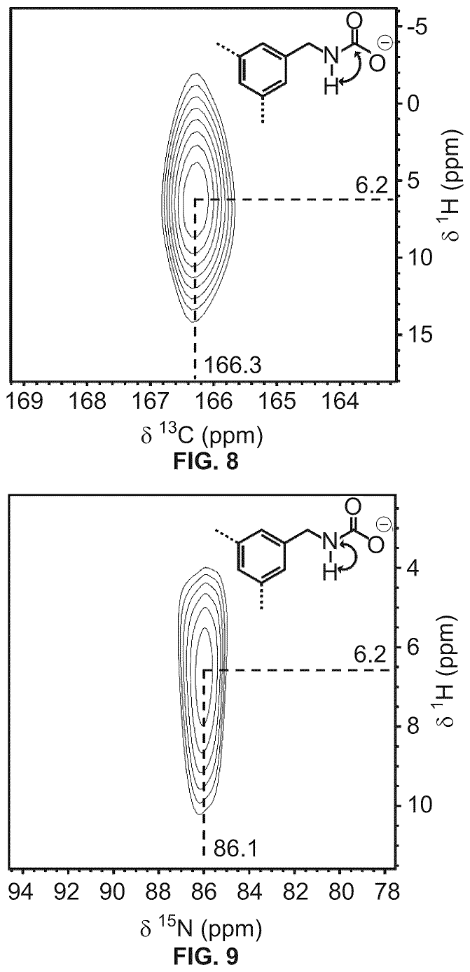

Solid-state two-dimensional heteronuclear correlation (HETCOR) spectra collected for ¹⁵N-labeled TriH dosed at 295 K with humidified ¹³CO₂ (1 atm) feature correlations at 6.2 and 166.2 ppm (¹H→¹³C) and 6.2 and 86 ppm (¹H→¹⁵N) shown in the plots of FIG. 8 and FIG. 9. These correlations were assigned to carbamate ¹H, ¹³C, and the ¹⁵N nuclei were based on these correlations.

### Example 3

Sorption characterization of TriH was initially performed using single component CO₂ gas sources. The absorption capacity of TriH was first characterized via thermogravimetric analysis (TGA) under a dynamic flow of CO₂. Roughly 2.5 mg of TriHCO₂ was activated under flowing N₂ at 25 mL/min and 100° C. before cooling TriH to 30° C. Then, the inlet stream was switched to CO₂. The measured mass change, corresponding to absorption capacity, was then recorded.

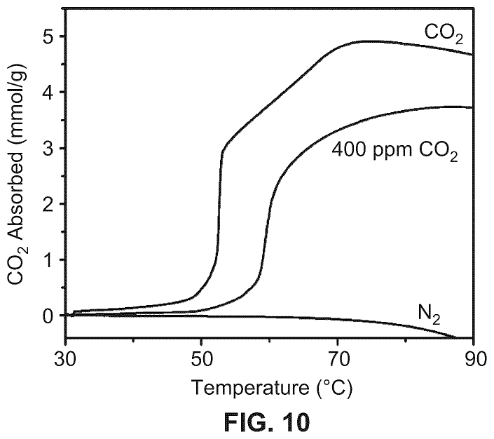

Under dry conditions and continuous heating at 0.25° C./min, step-shaped absorption under a pure stream of CO₂ occurs, which is indicative of cooperative sorption as demonstrated in FIG. 10. At 52° C., the sorption capacity of TriH under pure CO₂ is 12.9 g CO₂/100 g (2.93 mmol/g) and peaks at 75° C. with a capacity of 21.5 g CO₂/100 g (4.89 mmol/g). With absorption under pure CO₂ evident, an assessment of the CO₂ capture performance of TriH at CO₂ concentrations closer to that found in air was conducted.

Continuously heating TriH at a ramp rate of 0.1° C./min under a stream of 400 ppm CO₂ diluted with N₂ resulted in a shift in the absorption step to higher temperatures. Stepwise CO₂ sorption begins at 63° C. with a capacity of 12.0 g CO₂/100 g (2.72 mmol/g) and peaks at 87° C. with a capacity of 16.4 g CO2/100 g (3.73 mmol/g).

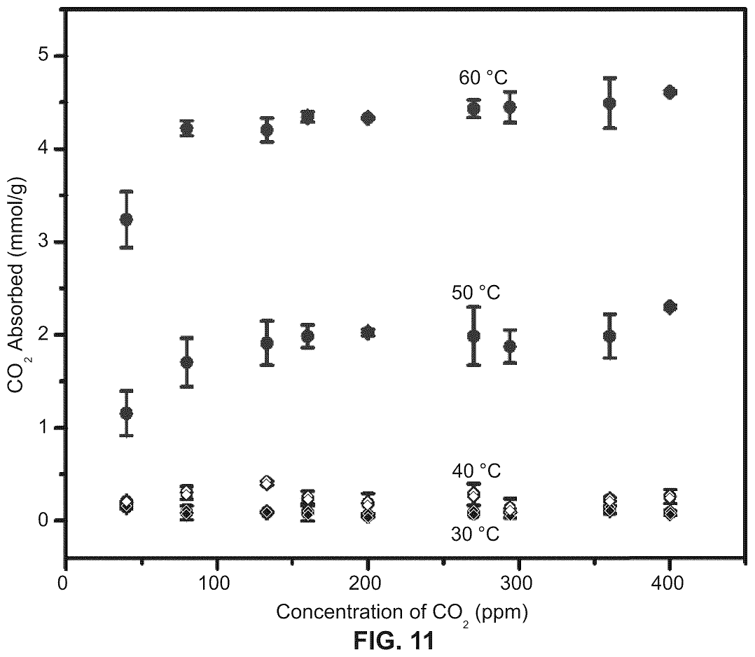

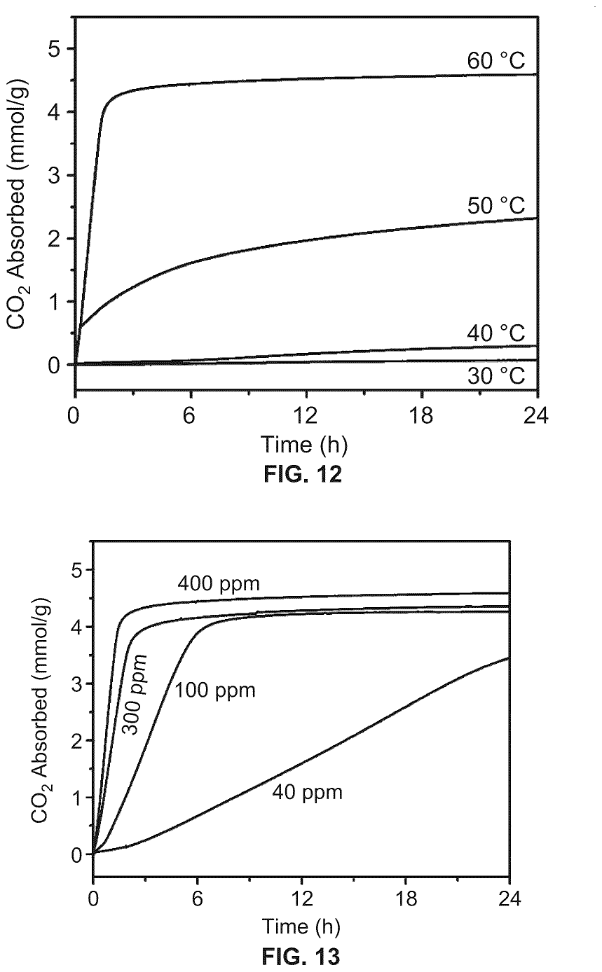

Isothermal characterizations of TriH under ultra-dilute streams of CO₂ were performed to assess the sorption performance of TriH at different temperatures is shown in FIG. 11. The TriH was activated under flowing N₂ at 100° C. before cooling to the desired temperature. The inlet stream was then switched to a custom-mixed blend of CO₂ diluted with N₂. TriH was dosed with CO₂ streams ranging between 40 ppm and 400 ppm CO₂ for 24 hours before recording gravimetric CO₂ sorption. Even at pressures as low as 40 ppm CO₂, TriH exhibits a CO₂ capacity of 15.2 g CO₂/100 g (3.45 mmol/g). Above 80 ppm of CO₂, the CO₂ absorption capacity of TriH is influenced heavily by temperature, attributed to a temperature dependent equilibrium between the amine phase and ammonium carbamate phase. Sorption kinetics are also enhanced with increased temperature, as TriH at 60° C. equilibrates after several hours as seen in FIG. 12.

In situ PXRD patterns of TriH while heating under a dry stream of pure CO₂ were also collected to identify a phase transition associated with CO₂ sorption as seen in FIG. 13. Beginning at 52° C., there are gradual changes to the positions, intensities, and widths of the diffraction peaks. Peaks corresponding to TriH decrease in intensity while peaks corresponding to a new phase increase in intensity. The phase transition completes at 80° C. which agrees with the gradual increase in CO₂ sorption identified by TGA.

### Example 4

The impact of humidity on the direct air capture capabilities of TriH was evaluated. The relative humidity (RH) of air varies widely, and daily temperature fluctuations further vary the absolute water content in air. As a consequence of the complexity of water content, a custom-built multi-component breakthrough analyzer was constructed utilizing a heated steam bubbler and a separately controlled furnace to independently vary relative humidity and temperature. Such customization was necessary to enable the study of TriH under various conditions relevant for ambient DAC. As expected, based on dry TGA results, TriH exposed to a stream of 400 ppm CO₂ at 50 SCCM and 0% RH did not demonstrate CO₂ sorption.

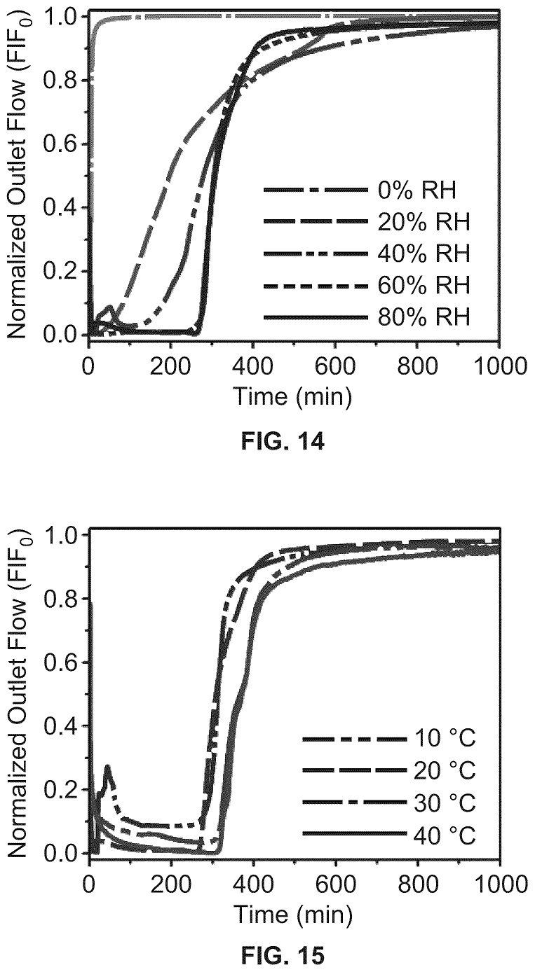

Increasing the RH to 20% resulted in a dramatic increase in CO₂ sorption capacity to 20.02 g CO₂/100 g (4.55 mmol/g) as shown in FIG. 14. This indicated a DAC capacity currently higher than any reported solid-state DAC sorbent. Increasing relative humidity at 20° C. further increases CO₂ capacity to 28.25 g CO₂/100 g (6.42 mmol/g) at 80% RH. Also, CO₂ sorption kinetics increases as the breakthrough profile becomes steeper.

As daily climates also fluctuate widely in temperature, the temperature effects on the sorption performance of TriH were also evaluated. At 80% RH and under a stream of 400 ppm CO₂, the CO₂ absorption capacity of TriH increases with temperature from 10° C. to 40° C. as seen in FIG. 15. At 10° C., the breakthrough capacity of TriH (24.60 g /100 g, 5.59 mmol/g) may be reduced by the minimal absolute water content in the inlet stream, as a reduced but non-zero concentration of CO₂ was detected in the outlet stream.

The incomplete sorption of CO₂ under cooler conditions may indicate that sorption kinetics decreases with colder temperatures. Remarkably, at 40° C. the breakthrough capacity of TriH (31.77 g CO₂ /100 g, 7.22 mmol/g) is nearly double that of the highest solid-state DAC material that has been encountered in the literature.

In a real DAC process, air flow rates are much higher than those typically measured at the laboratory scale, by at least an order of magnitude. The impact of flow rate on the CO₂ capture properties of TriH was assessed by conducting additional breakthrough experiments with 400 ppm CO₂ in N₂ at 60% or 80% RH and 20° C. or 40° C., using flow rates of 100 sccm or 200 sccm.

In general, for a given temperature and RH, faster flow rates were associated with shorter breakthrough times. While changing the flow rate had no impact on CO₂ capacity at 40° C., faster flow rates at 20° C. were associated with higher capacities (e.g., 6.17(5) versus 8.27(2) mmol/g at 60% RH and 50 and 200 sccm, respectively), indicating that CO₂ absorption at this temperature is kinetically limited. At 100 and 200 sccm, the breakthrough capacities at 20° C. were larger than at 40° C., consistent with an entropic penalty associated with CO₂ absorption from the gas phase at higher temperatures. Significantly, a maximum capacity of 8.89 mmol/g was achieved at 20° C., 80% RH, and 200 sccm, which is the highest reported to date for any DAC material and approaches the maximum theoretical gravimetric capacity of TriH (9.14 mmol/g).

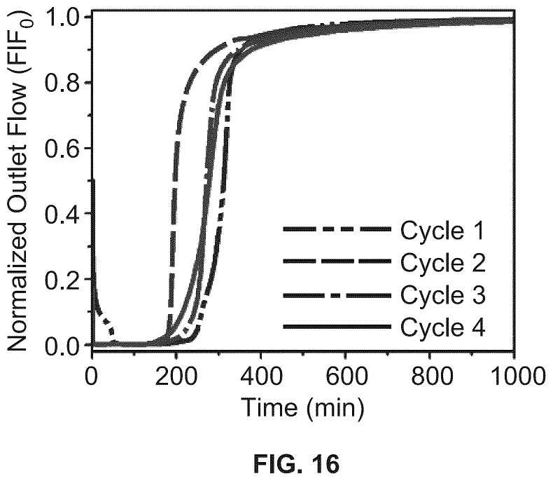

Lastly, cycling experiments were conducted using a 420 ppm CO₂ stream balanced with 21% O₂ and 79% N₂ content, humidified to 60% RH, and dosed at 20° C. are shown in FIG. 16. These conditions were chosen to simulate conditions like air. Successive desorption experiments were conducted with a dry N₂ stream at 110° C. for at most three hours to target 80% CO₂ desorption. Incomplete desorption of CO₂ was utilized to maximize sorbent stability.

Further cycling experiments were conducted with absorption at 20° C. under a flowing (200 sccm) gas stream containing 420 ppm CO₂, 21% O₂, and 79% N₂ at 80% RH (FIG. 14) and desorption under flowing (100 sccm) dry N₂ at 110° C. for 10 min. In the first absorption run, TriH absorbed 6.0 mmol CO₂/g, similar to the capacity measured under humid 400 ppm CO₂ at 80% RH after 3 h. Notably, this result suggests that O₂ does not significantly impact CO₂ uptake under these conditions. Only 1.8 mmol CO₂/g were recovered in the first desorption run, and the same quantity of CO₂ was subsequently captured in the second absorption run.

Surprisingly, however, 2.4 mmol/g was recovered in the subsequent desorption run. The quantity of CO₂ absorbed generally continued to increase until the ninth cycle (to 4.5 mmol/g), and the quantity of CO₂ desorbed increased to 4.1 mmol/g after the fifth cycle, and then fluctuated between 3.3 and 4.4 mmol/g in the latter cycles.

### Example 5

As TriH is the first in its class of molecular polyamines for DAC applications, there exists many variations that remain in the class for DAC and other separations. The phase transition and CO₂ absorption process of TriH material described herein can be broadly applied to other organic polyamines that are capable of forming ammonium carbamate network solids. A deeper understanding of the structure-function relationship between molecular polyamines and their DAC properties will lead to the identification of materials that more efficiently remove CO₂ from air or other sources.

First, a modification of the rigid aryl core of the TriH molecule would yield heavier analogs of TriH that are expected to have greater thermal stability than TriH as illustrated in FIG. 17. For example, the materials can be tuned by increasing the size of the rigid core by selecting a benzene, naphthalene, anthracene or pyrene core.

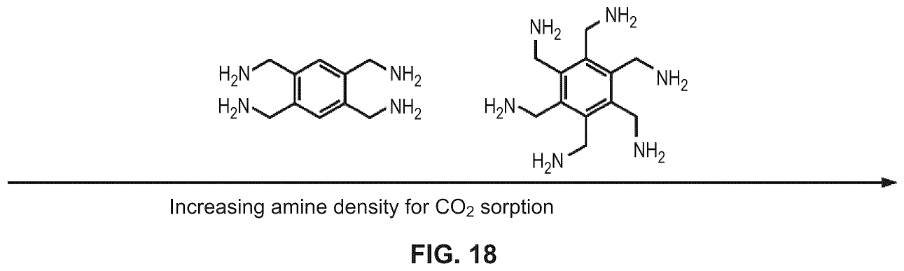

Second, higher sorption capacities can be realized with additional methylamine moieties to increase the concentration of amine groups as illustrated in FIG. 18. This modification would enable greater quantities of CO₂ captured and result in an overall increased rate of CO₂ sorption.

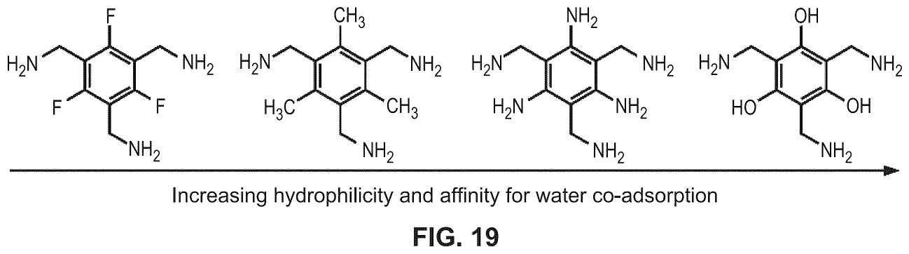

Additionally, molecular analogs of TriH with aryl functionalization are expected to increase hydrophilicity of the molecular polymer material as illustrated in FIG. 19. Since a direct relationship between relative humidity and CO₂ sorption kinetics has been observed, it is believed that increasing hydrophilicity in the material may result in faster CO₂ sorption kinetics. For example, core substituents such as F, CH₃ and OH are configured to increase hydrophilicity and saturation kinetics for CO₂.

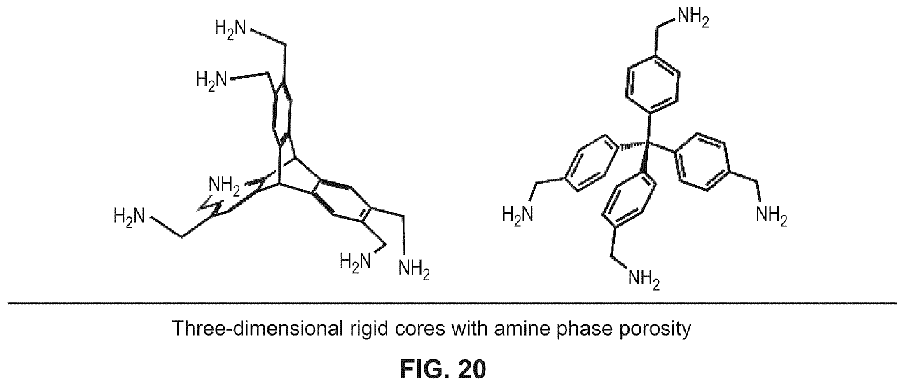

Lastly, there exists many different two-dimensional and three-dimensional rigid cores that can undergo methylamine functionalization as shown schematically in FIG. 20. Not only would different rigid cores establish further insight into structure-function relationships related to CO₂ sorption, but we also expect larger rigid cores to irregularly pack to afford enhanced porosity and enhanced sorption kinetics.

From the description herein, it will be appreciated that the present disclosure encompasses multiple implementations of the technology which include, but are not limited to, the following:

A composition for carbon dioxide gas separations, the composition comprising: a substrate; and a plurality of molecular polyamines coupled to the substrate, the molecular polyamines capable of a phase transition upon CO₂ capture.

The composition of any previous or following implementation, wherein the molecular polyamines comprise: a rigid core; one or more amines; and a plurality of organic linkers, each linker bonded to at least one amine and to the rigid core, the linkers linking the amines to the core.

The composition of any previous or following implementation, wherein the rigid core of the molecular polyamines comprises a naphthalene core.

The composition of any previous or following implementation, wherein the rigid core of the molecular polyamines comprises an anthracene core.

The composition of any previous or following implementation, wherein the rigid core of the molecular polyamines comprises a pyrene core.

The composition of any previous or following implementation, the rigid core further comprising at least one substituent selected from the group of substituents consisting of F, CH₃ and OH, the substituents configured to increase hydrophilicity and saturation kinetics for CO₂.

The composition of any previous or following implementation, wherein the organic linkers are chains of one, two or three carbon atoms.

The composition of any previous or following implementation, wherein the substrate comprises a porous membrane or thin film, the substrate configured to improve thermal stability and cycling capacity.

The composition of any previous or following implementation, wherein the substrate comprises a column with a coating of a thin film or polymer powder configured to minimize energy costs for thermal regeneration.

The composition of any previous or following implementation, wherein the molecular polyamine comprises triamine 1,3,5-tris(aminomethyl)benzene C₆H₃(CH₂NH₂)₃ (TriH).

A method for carbon dioxide gas separations, the method comprising: (a) providing a bed of solid-state molecular polyamines capable of a phase transition upon CO₂ capture; (b) exposing the bed of solid-state molecular polyamines to a flow of gases containing CO₂ to be captured; (c) adsorbing CO₂ with the solid-state molecular polyamines producing an ammonium carbamate species that engage in intermolecular hydrogen bonding interactions to form a crystalline network solid; and (d) isolating the crystalline material after a period of time and desorbing CO₂ with heating and a vacuum swing.

The method of any previous or following implementation, wherein the molecular polyamines comprise: a rigid core; one or more amines; and a plurality of organic linkers, each linker bonded to at least one amine and to the rigid core, the linkers linking the amines to the core.

The method of any previous or following implementation, wherein the rigid core of the molecular polyamines is selected from the group of cores consisting of benzene, naphthalene, anthracene and pyrene.

The method of any previous or following implementation, wherein the rigid core further comprises at least one substituent selected from the group of substituents consisting of F, CH₃ and OH, the substituents configured to increase hydrophilicity and saturation kinetics for CO₂.

The method of any previous or following implementation, wherein the organic linkers are chains of one, two or three carbon atoms.

The method of any previous or following implementation, wherein the solid-state molecular polyamines comprise triamine 1,3,5-tris(aminomethyl)benzene C₆H₃(CH₂NH₂)₃ (TriH).

The method of any previous or following implementation, further comprising controlling gas flow temperature to reduce potential volatilization of the bed during adsorption.

The method of any previous or following implementation, further comprising controlling relative humidity of the gas flow to optimize CO₂ sorption capacity.

A method for carbon dioxide gas separations, the method comprising: (a) providing a plurality of solid-state molecular polyamines capable of a phase transition upon CO₂ capture the molecular polyamines having a rigid core, one or more amines; and a plurality of organic linkers, each linker bonded to at least one amine and to the rigid core; (b) exposing the solid-state molecular polyamines to a flow of gases containing CO₂ to be captured; (c) adsorbing CO₂ with the solid-state molecular polyamines producing an ammonium carbamate species that engage in intermolecular hydrogen bonding interactions to form a crystalline network solid; and (d) isolating adsorbed CO₂.

The method of any previous implementation, wherein the rigid core of the molecular polyamines is selected from the group of cores consisting of benzene, naphthalene, anthracene and pyrene.

As used herein, the term “implementation” is intended to include, without limitation, embodiments, examples, or other forms of practicing the technology described herein.

As used herein, the singular terms “a,” “an,” and “the” may include plural referents unless the context clearly dictates otherwise. Reference to an object in the singular is not intended to mean “one and only one” unless explicitly so stated, but rather “one or more.”

Phrasing constructs, such as “A, B and/or C”, within the present disclosure describe where either A, B, or C can be present, or any combination of items A, B and C. Phrasing constructs indicating, such as “at least one of” followed by listing a group of elements, indicates that at least one of these groups of elements is present, which includes any possible combination of the listed elements as applicable.

References in this disclosure referring to “an embodiment”, “at least one embodiment” or similar embodiment wording indicates that a particular feature, structure, or characteristic described in connection with a described embodiment is included in at least one embodiment of the present disclosure. Thus, these various embodiment phrases are not necessarily all referring to the same embodiment, or to a specific embodiment which differs from all the other embodiments being described. The embodiment phrasing should be construed to mean that the particular features, structures, or characteristics of a given embodiment may be combined in any suitable manner in one or more embodiments of the disclosed apparatus, system, or method.

As used herein, the term “set” refers to a collection of one or more objects. Thus, for example, a set of objects can include a single object or multiple objects.

Relational terms such as first and second, top and bottom, upper and lower, left and right, and the like, may be used solely to distinguish one entity or action from another entity or action without necessarily requiring or implying any actual such relationship or order between such entities or actions.

The terms “comprises,” “comprising,” “has”, “having,” “includes”, “including,” “contains”, “containing” or any other variation thereof, are intended to cover a non-exclusive inclusion, such that a process, method, article, apparatus, or system, that comprises, has, includes, or contains a list of elements does not include only those elements but may include other elements not expressly listed or inherent to such process, method, article, apparatus, or system. An element proceeded by “comprises . . . a”, “has . . . a”, “includes . . . a”, “contains . . . a” does not, without more constraints, preclude the existence of additional identical elements in the process, method, article, apparatus, or system, that comprises, has, includes, contains the element.

As used herein, the terms “approximately”, “approximate”, “substantially”, “substantial”, “essentially”, and “about”, or any other version thereof, are used to describe and account for small variations. When used in conjunction with an event or circumstance, the terms can refer to instances in which the event or circumstance occurs precisely as well as instances in which the event or circumstance occurs to a close approximation. When used in conjunction with a numerical value, the terms can refer to a range of variation of less than or equal to ±10% of that numerical value, such as less than or equal to ±5%, less than or equal to ±4%, less than or equal to ±3%, less than or equal to ±2%, less than or equal to ±1 %, less than or equal to ±0.5%, less than or equal to ±0.1 %, or less than or equal to ±0.05%. For example, “substantially” aligned can refer to a range of angular variation of less than or equal to ±10°, such as less than or equal to ±5°, less than or equal to ±4°, less than or equal to ±3°, less than or equal to ±2°, less than or equal to ±1°, less than or equal to ±0.5°, less than or equal to ±0.1°, or less than or equal to ±0.05°.

Additionally, amounts, ratios, and other numerical values may sometimes be presented herein in a range format. It is to be understood that such range format is used for convenience and brevity and should be understood flexibly to include numerical values explicitly specified as limits of a range, but also to include all individual numerical values or sub-ranges encompassed within that range as if each numerical value and sub-range is explicitly specified. For example, a ratio in the range of about 1 to about 200 should be understood to include the explicitly recited limits of about 1 and about 200, but also to include individual ratios such as about 2, about 3, and about 4, and sub-ranges such as about 10 to about 50, about 20 to about 100, and so forth.

The term “coupled” as used herein is defined as connected, although not necessarily directly and not necessarily mechanically. A device or structure that is “configured” in a certain way is configured in at least that way, but may also be configured in ways that are not listed.

Benefits, advantages, solutions to problems, and any element(s) that may cause any benefit, advantage, or solution to occur or become more pronounced are not to be construed as a critical, required, or essential feature or element of the technology described herein or any or all the claims.

In addition, in the foregoing disclosure various features may be grouped together in various embodiments for the purpose of streamlining the disclosure. This method of disclosure is not to be interpreted as reflecting an intention that the claimed embodiments require more features than are expressly recited in each claim. Inventive subject matter can lie in less than all features of a single disclosed embodiment.

The abstract of the disclosure is provided to allow the reader to quickly ascertain the nature of the technical disclosure. It is submitted with the understanding that it will not be used to interpret or limit the scope or meaning of the claims.

It will be appreciated that the practice of some jurisdictions may require deletion of one or more portions of the disclosure after the application is filed. Accordingly, the reader should consult the application as filed for the original content of the disclosure. Any deletion of content of the disclosure should not be construed as a disclaimer, forfeiture, or dedication to the public of any subject matter of the application as originally filed.

All text in a drawing figure is hereby incorporated into the disclosure and is to be treated as part of the written description of the drawing figure.

The following claims are hereby incorporated into the disclosure, with each claim standing on its own as a separately claimed subject matter.

Although the description herein contains many details, these should not be construed as limiting the scope of the disclosure, but as merely providing illustrations of some of the presently preferred embodiments. Therefore, it will be appreciated that the scope of the disclosure fully encompasses other embodiments which may become obvious to those skilled in the art.

All structural and functional equivalents to the elements of the disclosed embodiments that are known to those of ordinary skill in the art are expressly incorporated herein by reference and are intended to be encompassed by the present claims. Furthermore, no element, component, or method step in the present disclosure is intended to be dedicated to the public regardless of whether the element, component, or method step is explicitly recited in the claims. No claim element herein is to be construed as a “means plus function” element unless the element is expressly recited using the phrase “means for”. No claim element herein is to be construed as a “step plus function” element unless the element is expressly recited using the phrase “step for”.

What is claimed is:

1. A composition for carbon dioxide gas separations, the composition comprising:
a substrate; and
a plurality of molecular polyamines coupled to the substrate, said molecular polyamines capable of a phase transition upon CO₂ capture.

2. The composition of claim 1, wherein said molecular polyamines comprise:
a rigid core;
one or more amines; and
a plurality of organic linkers, each linker bonded to at least one amine and to the rigid core, said linkers linking the amines to the core.

3. The composition of claim 2, wherein said rigid core of the molecular polyamines comprises a naphthalene core.

4. The composition of claim 2, wherein said rigid core of the molecular polyamines comprises an anthracene core.

5. The composition of claim 2, wherein said rigid core of the molecular polyamines comprises a pyrene core.

6. The composition of claim 2, said rigid core further comprising:
at least one substituent selected from the group of substituents consisting of F, CH₃ and OH, said substituents configured to increase hydrophilicity and saturation kinetics for CO₂.

7. The composition of claim 2, wherein said organic linkers are chains of one, two or three carbon atoms.

8. The composition of claim 1, wherein the substrate comprises a porous membrane or thin film, said substrate configured to improve thermal stability and cycling capacity.

9. The composition of claim 1, wherein the substrate comprises a
column with a coating of a thin film or polymer powder configured to minimize energy costs for thermal regeneration.

10. The composition of claim 1, wherein said molecular polyamine comprises triamine 1,3,5-tris(aminomethyl)benzene C₆H₃(CH₂NH₂)₃ (TriH).

11. A method for carbon dioxide gas separations, the method comprising:
(a) providing a bed of solid-state molecular polyamines capable of a phase transition upon CO₂ capture;
(b) exposing the bed of solid-state molecular polyamines to a flow of gases containing CO₂ to be captured;
(c) adsorbing CO₂ with the solid-state molecular polyamines producing an ammonium carbamate species that engage in intermolecular hydrogen bonding interactions to form a crystalline network solid; and
(d) isolating the crystalline material after a period of time and desorbing CO₂ with heating and a vacuum swing.

12. The method of claim 11, wherein said molecular polyamines comprise:
a rigid core;
one or more amines; and
a plurality of organic linkers, each linker bonded to at least one amine and to the rigid core, said linkers linking the amines to the core.

13. The method of claim 12, wherein said rigid core of the molecular polyamines is selected from the group of cores consisting of benzene, naphthalene, anthracene and pyrene.

14. The method of claim 12, wherein said rigid core further comprises:
at least one substituent selected from the group of substituents consisting of F, CH₃ and OH, said substituents configured to increase hydrophilicity and saturation kinetics for CO₂.

15. The method of claim 12, wherein said organic linkers are chains of one, two or three carbon atoms.

16. The method of claim 11, wherein said solid-state molecular polyamines comprises triamine 1,3,5-tris(aminomethyl)benzene C₆H₃(CH₂NH₂)₃ (TriH).

17. The method of claim 11, further comprising:
controlling gas flow temperature to reduce potential volatilization of the bed during adsorption.

18. The method of claim 11, further comprising:
controlling relative humidity of the gas flow to optimize CO₂ sorption capacity.

19. A method for carbon dioxide gas separations, the method comprising:
(a) providing a plurality of solid-state molecular polyamines capable of a phase transition upon CO₂ capture said molecular polyamines having a rigid core, one or more amines; and a plurality of organic linkers, each linker bonded to at least one amine and to the rigid core;
(b) exposing the solid-state molecular polyamines to a flow of gases containing CO₂ to be captured;
(c) adsorbing CO₂ with the solid-state molecular polyamines producing an ammonium carbamate species that engage in intermolecular hydrogen bonding interactions to form a crystalline network solid; and
(d) isolating adsorbed CO₂.

20. The method of claim 19, wherein said rigid core of the molecular polyamines is selected from the group of cores consisting of benzene, naphthalene, anthracene and pyrene.
